(19) United States
(12) Patent Application Publication
(10) Pub. No.: US 2007/0246234 A1
(43) Pub. Date: Oct. 25, 2007

(54) FIRE SUPPRESSION SYSTEM

(76) Inventor: William Vegso, Charlotte, NC (US)

Correspondence Address: ADAMS EVANS P.A., Suite 2350 Charlotte Plaza, 201 South College Street, CHARLOTTE, NC, 28244, US

(21) Appl. No.: 11/379,440

(22) Filed: Apr. 20, 2006

(51) Int. Cl. A62C 3/00

(52) U.S. Cl. 169/65; 169/59; 169/60

(57) ABSTRACT

A fire suppression system that can be manually or automatically activated. The fire suppression system having a container for storing a fire suppression agent, a nozzle connected to the container by a conduit, an actuating device remote from the container, a control device, and a cable interconnecting the actuating device and control device. The nozzle receives the fire suppression agent from the container and distributes the fire suppression agent onto a protected area. The actuating device generates a mechanical control motion that causes the control device to discharge the fire suppression agent from the container. The cable transmits the control motion from the actuating device to the control device and includes a core and a continuous outer sheath that allows the core to move within the sheath along the length of the cable and around corners without the use of pulleys.

### TECHNICAL AND BACKGROUND OF THE INVENTION

The present invention relates to the field of fire suppression systems. In particular, the invention relates to a UL-300/1254 listed pre-engineered fire suppression system for restaurant cooking areas and dry-chemical industrial applications that uses push-pull type cables to interconnect input and output devices used in these systems.

Fire suppression systems are commonly used to protect commercial buildings where flammable liquids are present, such as restaurants where cooking units, such as grills and deep-fryer units, are being used, and where the grease used in the deep-fryer units and on the grills can pose a significant fire hazard.

Typically, these fire suppression systems use electrical metal tubing (“EMT”) conduit sections and corner pulleys to route a cable between a control unit and a mechanical device, such as a remote pull station or fusible link. The EMT conduit sections and pulleys allow the cable to be routed around objects and corners while allowing the cable to move along its length inside of the EMT conduit sections between the mechanical device and the control unit. However, the use of EMT conduit sections and corner pulleys results in increased installation time due to cutting, measuring, mounting and routing of the EMT conduit sections, installation of the pulleys, and threading the cable through the EMT conduit sections. Additionally, the cable is exposed at the corners to dirt, grease, and other environmental conditions that can accumulate on the cable, causing jamming or a malfunction.

Accordingly, there is a need for a fire suppression system that is easily installed, thereby reducing installation times and expense, and less prone to jamming or other malfunctions.

### SUMMARY OF THE INVENTION

Therefore it is an object of the invention to provide a fire suppression system that can be routed over obstacles and around corners without the need for corner pulleys or EMT.

It is another object of the invention to provide a fire suppression system that uses a cable that is not exposed to environmental conditions at junctures, such as a corner, where the cable changes direction.

It is another object of the invention to provide a fire suppression system that can be installed without having to measure, cut, and mount EMT conduit sections.

It is another object of the invention to provide a fire suppression system that uses a reciprocating cable having a moveable core to connect a mechanical device to a control unit.

These and other objects of the present invention are achieved in the preferred embodiments disclosed below by providing a fire suppression system. The fire suppression system includes a container for storing a fire suppression agent, a nozzle connected to the container by a conduit, an actuating device remote from the container, a control device, and a push-pull cable interconnecting the actuating device and control device. The nozzle receives the fire suppression agent from the container and distributes the fire suppression agent onto a protected area. The actuating device generates a mechanical control motion that causes the control device to discharge the fire suppression agent from the container. The cable transmits the control motion from the actuating device to the control device, and includes a core and a continuous outer sheath that allows the core to move within the sheath along the length of the cable and around corners without the use of pulleys.

According to another preferred embodiment of the invention, the actuating device is a fusible link that automatically generates the control motion.

According to another preferred embodiment of the invention, the actuating device is a lever that allows the control motion to be generated manually.

According to another preferred embodiment of the invention, the control device is operably connected to a valve connected to the container for allowing the fire suppression agent to be discharged.

According to another preferred embodiment of the invention, the cable is a push-pull type cable.

According to another preferred embodiment of the invention, further including a second actuating device remote from the container operable to generate a mechanical control motion.

According to another preferred embodiment of the invention, the second actuating device allows the control motion to be generated manually.

According to another preferred embodiment of the invention, the second actuating device is a fusible link that automatically generates the control motion.

According to another preferred embodiment of the invention, a fire suppression system. The fire suppression system includes a container for storing a fire suppression agent, a nozzle connected to the container by a conduit, an actuating device remote from the container, a control device, and a cable interconnecting the actuating device and control device. The nozzle receives the fire suppression agent from the container and distributes the fire suppression agent onto a protected area. The actuating device generates a mechanical control motion that causes the control device to discharge the fire suppression agent from the container. The cable transmits the control motion from the actuating device to the control device, and includes a core and a continuous outer sheath that allows the core to move within the sheath along the length of the cable. The cable is run along a route having at least one change in direction.

According to another preferred embodiment of the invention, the control device is operably connected to a valve connected to the container for allowing the fire suppression agent to be discharged.

According to another preferred embodiment of the invention, in a fire suppression system having a container for storing a fire suppression agent, an actuating device, and discharging means for discharging the fire suppression agent from the container through a nozzle in response to a control motion generated by the actuating device, the improvement includes a cable interconnecting the actuating device and the discharging means. The cable being adapted to transmit the control motion from the actuating device to the discharging means, wherein the cable includes a core and a continuous outer sheath that allows the core to move within the sheath along the length of the cable.

According to another preferred embodiment of the invention, the cable is run along a route having at least one change in direction.

According to another preferred embodiment of the invention, the discharging means is a valve.

### BRIEF DESCRIPTION OF THE DRAWINGS

The invention may be best understood by reference to the following description in conjunction with the accompanying drawing figures in which:

FIG. 1 is a prior art fire suppression system for a restaurant; and

FIG. 2 is a fire suppression system according to an embodiment of the invention.

### DESCRIPTION OF THE PREFERRED EMBODIMENT AND BEST MODE

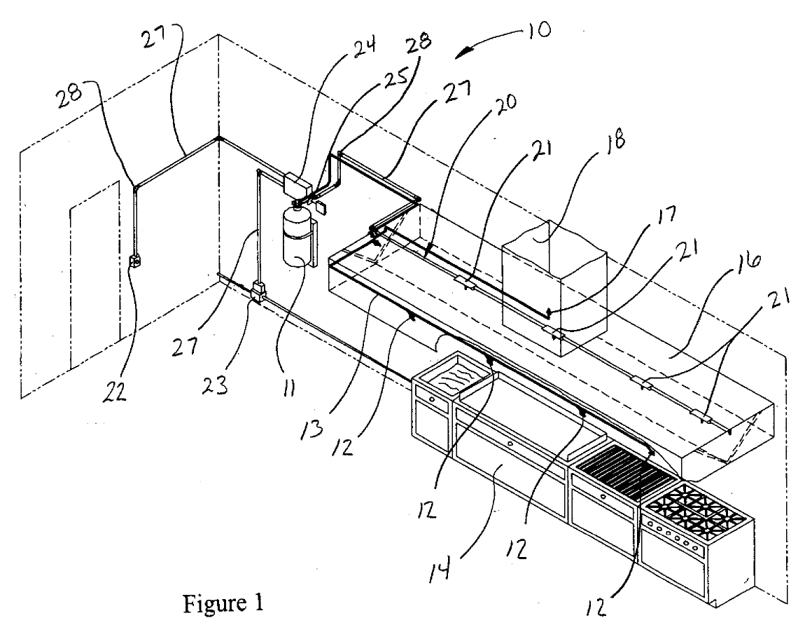

Referring now specifically to the drawings, a prior art fire suppression system 10 for a restaurant is shown in FIG. 1. The system 10 includes a storage container, such as a pressurized cylinder 11 for containing a fire suppression agent, and a plurality of nozzles 12 connected to the cylinder 11 by conduit 13 for spraying the fire suppression agent onto a protected area on a cooking unit 14. As shown, the nozzles 12 are positioned in the exhaust hood 16 above the cooking unit 14. An additional nozzle 17 is positioned for spraying fire suppression agent into an exhaust duct 18 of the hood 16.

A fusible link line 20 having a series of fusible links 21, a remote pull station 22, and a gas shutoff valve 23 are connected to a control unit 24. The control unit 24 actuates a valve 25 on the cylinder 11 to allow the fire suppression agent to be expelled through the nozzles 12 and 17 in the event of a fire.

As illustrated, the fusible links 21, remote pull station 22, and the gas shutoff valve 23 are connected to the control unit 24 using EMT conduit sections 27 and corner pulleys 28 for each change in direction. A steel cable is threaded through the EMT conduit sections 27 and over the pulleys 28.

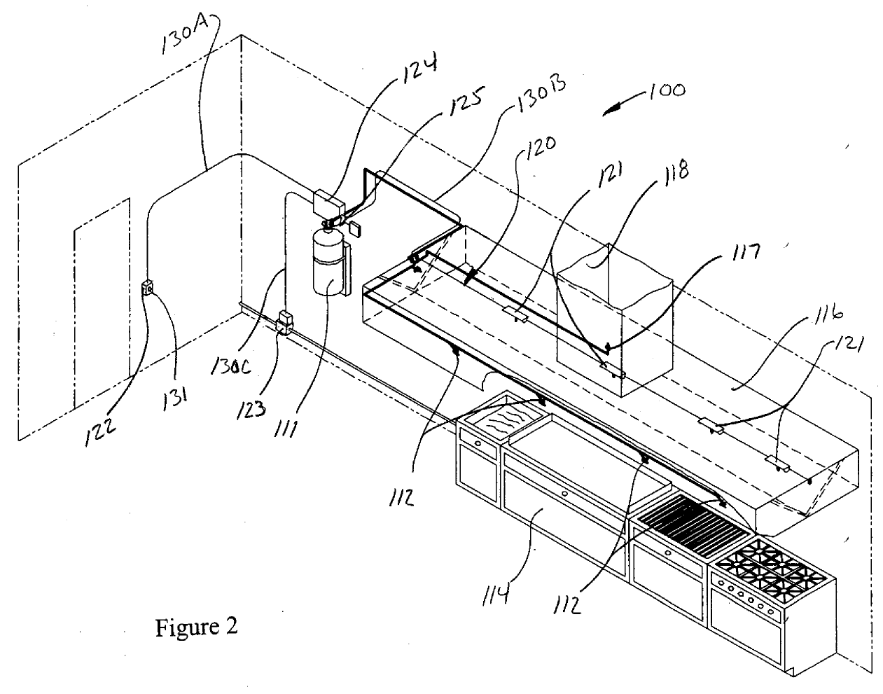

A fire suppression system according to an embodiment of the invention is illustrated in FIG. 2 and shown generally at reference numeral 100. The system 100 is illustrated in a restaurant setting; however, it should be appreciated that the system 100 may be used in any setting where fire suppression is needed.

Like system 10, system 100 includes a storage container, such as a pressurized cylinder 111 for containing a fire suppression agent, and nozzles 112 and 117 positioned in an exhaust hood 116 and exhaust duct 118, respectively. The nozzles 112 and 117 are connected to the cylinder 111 by conduit 113 for spraying the fire suppression agent onto a protected area on a cooking unit 114. As used herein, the term “conduit” refers to any means, such as piping, for delivering a fire suppression agent to a protected area.

A control unit 124 is positioned for actuating a valve 125 on the cylinder 111 and releasing the fire suppression agent. A remote pull station 122 positioned on a wall remote of the cylinder 111 is connected to the control unit 124 by a shielded cable 130A. The remote pull station 122 has an actuator 131, such as a button or lever, for actuating the control unit 124 manually. A fusible link line 120 having fusible links 121 connected in series under the hood 116 and connected to the control unit 124 by shielded cable 130B. The fusible link line 120 is connected to the control unit 124 under tension. A gas shutoff valve 123 is connected to the control unit 124 by a shielded cable 130C.

The cables 130A-130C include a flexible core restrained in a housing which prevents lateral motion, but allows motion along the length of the cables 130A-130C. This structure, as shown, allows the cables 130A-130C to be routed around obstacles and corners without the use of pulleys or having to cut individual pieces of tubing. For example, in FIG. 1, the system 10 uses fourteen EMT conduit sections 27 and seven corner pulleys 28 to route a cable threaded therethrough. However in FIG. 2, the cables 130A-130C are routed along the same paths as the EMT conduit sections 27, but no pulleys are required. In this particular example, the cables 130A-130C include a metallic wire encased in a plastic tube or spirally wrapped wire. These cables are commonly referred to as push-pull or reciprocating type cables, and are manufactured by SAVA Industries, Inc.

In a non-use state, the fusible link line 120 is maintained under tension, the valve 125 on the cylinder 111 is maintained in its normally closed state, and the gas shutoff valve 123 is maintained in a normally open state. When a fire occurs, the system 100 is activated by either the remote pull station 122 or one of the fusible links 121 separating. The remote pull station 122 allows an individual to manually activate the system 100 by pushing or pulling the actuator 131. The actuator 131 moves the core of the cable 130A causing the valve 125 to open and the fire suppression agent to flow through the conduit 113 and out of the nozzles 112 and 117 to extinguish the fire.

In the event that the remote pull station 122 is not used, the fusible links 121 will separate upon reaching a specified temperature, releasing the tension on the fusible link line 120 and allowing the core of cable 130B to move, thereby causing the valve 125 to open. When the valve 125 is opened by either the remote pull station 122 or the fusible link line 120, the control unit 124 actuates the cable 130C, thereby closing the gas shutoff valve 123 to stop the flow of gas to the cooking unit 114. The control unit 124 may also cut off electricity to the building or interface with a building alarm system.

A fire suppression system is described above. Various details of the invention may be changed without departing from its scope. Furthermore, the foregoing description of the preferred embodiments of the invention and best mode for practicing the invention are provided for the purpose of illustration only and not for the purpose of limitation.

I claim:

1. A fire suppression system, comprising:
(a) a container for storing a fire suppression agent;
(b) at least one nozzle connected to the container by a conduit for receiving the fire suppression agent from the container and distributing the fire suppression agent onto a protected area;
(c) an actuating device remote from the container operable to generate a mechanical control motion;
(d) a control device effective to discharge the fire suppression agent from the container to the conduit in response to the control motion; and
(e) a push-pull cable interconnecting the actuating device and the control device, and adapted to transmit the control motion from the actuating device to the control device, wherein the cable includes a core and a continuous outer sheath that allows the core to move within the sheath along the length of the cable and around corners without the use of pulleys.

2. The fire suppression system according to claim 1, wherein the actuating device is a fusible link that automatically generates the control motion.

3. The fire suppression system according to claim 1, wherein the actuating device is a lever that allows the control motion to be generated manually.

4. The fire suppression system according to claim 1, wherein the control device is operably connected to a valve connected to the container for allowing the fire suppression agent to be discharged.

5. The fire suppression system according to claim 1, and further including a second actuating device remote from the container operable to generate a mechanical control motion.

6. The fire suppression system according to claim 5, wherein the second actuating device allows the control motion to be generated manually.

7. The fire suppression system according to claim 5, wherein the second actuating device is a fusible link that automatically generates the control motion.

8. The fire suppression system according to claim 1, and further including a gas shutoff valve for stopping the flow of gas to an appliance, the gas shutoff valve being connected to the control device by a push-pull cable, wherein the control device closes the gas shutoff valve in response to the control motion.

9. A fire suppression system, comprising:
(a) a container,for storing a fire suppression agent;
(b) at least one nozzle connected to the container by a conduit for receiving the fire suppression agent from the container and distributing the fire suppression agent onto a protected area;
(c) an actuating device remote from the container operable to generate a mechanical control motion;
(d) a control device effective to discharge the fire suppression agent from the container to the conduit in response to the control motion;
(e) a push-pull cable interconnecting the actuating device and the control device, and adapted to transmit the control motion from the actuating device to the control device, wherein the cable includes a core and a continuous outer sheath that allows the core to move within the sheath along the length of the cable, the cable being run along a route having at least one change in direction without the use of pulleys.

10. The fire suppression system according to claim 9, wherein the actuating device is a fusible link that automatically generates the control motion.

11. The fire suppression system according to claim 9, wherein the actuating device is a lever that allows the control motion to be generated manually.

12. The fire suppression system according to claim 9, wherein the control device is operably connected to a valve connected to the container for allowing the fire suppression agent to be discharged.

13. The fire suppression system according to claim 9, wherein the cable is a push-pull cable.

14. The fire suppression system according to claim 9, and further including a gas shutoff valve for stopping the flow of gas to an appliance, the gas shutoff valve being connected to the control device by a push-pull cable, wherein the control device closes the gas shutoff valve in response to the control motion.

15. In a fire suppression system having a container for storing a fire suppression agent, an actuating device, and discharging means for discharging the fire suppression agent from the container through a nozzle in response to a control motion generated by the actuating device, the improvement comprising:
(a) a cable interconnecting the actuating device and the discharging means, and adapted to transmit the control motion from the actuating device to the discharging means, wherein the cable includes a core and a continuous outer sheath that allows the core to move within the sheath along the length of the cable and around corners without the use of pulleys.

16. The fire suppression system according to claim 15, wherein the cable is a push-pull type cable.

17. The fire suppression system according to claim 15, wherein the cable is run along a route having at least one change in direction.

18. The fire suppression system according to claim 15, wherein the discharging means is a valve.

19. The fire suppression system according to claim 15, wherein the actuating device is a fusible link that automatically generates the control motion.

20. The fire suppression system according to claim 15, wherein the actuating device is a lever that allows the control motion to be generated manually.
